(19) United States
(12) Patent Application Publication
(10) Pub. No.: US 2026/0211238 A1
(43) Pub. Date: Jul. 23, 2026

(54) EXTENDED-REALITY GLASSES SYSTEM WITH ZOOM PROJECTION LENS

(71) Applicant: NATIONAL CENTRAL UNIVERSITY, Taoyuan City (TW)

(72) Inventors: Wen-Hsin SUN, Taoyuan City (TW); Huai-Chih CHANG, Taoyuan City (TW); Ching-Cherng SUN, Taoyuan City (TW); Tsung-Xian LEE, Taoyuan City (TW)

(21) Appl. No.: 19/094,779

(22) Filed: Mar. 28, 2025

(30) Foreign Application Priority Data
Jan. 23, 2025 (TW) 114103100

(51) Int. Cl. G02B 27/01

(52) U.S. Cl. CPC G02B 27/0172; G02B 2027/0174; G02B 2027/0178

(57) ABSTRACT

An extended-reality glasses system with a zoom projection lens includes: a light guide element having a first light-coupling portion, a second light-coupling portion, a third light-coupling portion, and a fourth light-coupling portion; a first volume holographic element corresponding in position, and optically coupled, to the first light-coupling portion; a second volume holographic element corresponding in position, and optically coupled, to the second light-coupling portion; and the zoom projection lens, which corresponds in position, and is optically coupled, to the third light-coupling portion. The extended-reality glasses system is so configured that its focal length can be changed without having to prepare, and switch between, a plurality of fixed-focal-length lenses, and that zooming in and out can be carried without affecting image quality.

### BACKGROUND OF THE INVENTION

### 1. Technical Field

The present invention relates to an extended-reality glasses system with a zoom projection lens. More particularly, the invention relates to an extended-reality glasses system that has a zoom projection lens and that is configured to combine a real environment and a virtual environment through a man-machine interaction device.

### 2. Description of Related Art

Extended reality (XR) is an “umbrella” term referring generally to a technology whereby computer text or graphics are superposed on, or incorporated into, a real and/or virtual environment or whereby a real environment is combined with a virtual one. XR includes augmented reality (AR), virtual reality (VR), and mixed reality (MR). While the three “realities” have some common functions and requirements, each of them has distinct purposes and individual technical features.

Current XR systems almost invariably use a fixed-focal-length lens; therefore, zooming in and out cannot but be carried out digitally. Digital zoom, however, not only additionally requires the assistance of software, but also results in blurry images. Some XR systems use mechanical zoom, but such a zoom mechanism is disadvantaged by structural complexity, bulkiness, and heavy weight. Moreover, none of the conventional XR system lenses provides line resolution optimization, so distortion around the edge of an image can be clearly visible to the naked eye and may in some cases compromise users'judgment.

### BRIEF SUMMARY OF THE INVENTION

The present invention provides an extended-reality glasses system that has a zoom projection lens. The system is intended to solve the aforesaid problems of existing extended-reality glasses systems, namely the blur of images created by digital zoom, the bulkiness and heavy weight of a mechanical zoom system, and visual distortion caused by the low line resolution of the conventional extended-reality system lenses.

The present invention provides an extended-reality glasses system that has a zoom projection lens. The extended-reality glasses system includes: a light guide element that has a first light-coupling portion, a second light-coupling portion, a third light-coupling portion, and a fourth light-coupling portion; a first volume holographic element that is provided at a position corresponding to the first light-coupling portion and is optically coupled to the first light-coupling portion; a second volume holographic element that is provided at a position corresponding to the second light-coupling portion and is optically coupled to the second light-coupling portion; and a zoom projection lens that is provided at a position corresponding to the third light-coupling portion and is optically coupled to the third light-coupling portion.

Implementation of the present invention can achieve at least the following advantageous effects:
1. The focal length of the system can be changed without having to prepare, and switch between, a plurality of fixed-focal-length lenses, and zooming in and out can be carried out without affecting image quality.
2. Line resolution can be optimized so that there will not be visually perceivable distortion around the edge of an image.
3. Stepless zoom can be performed to effect changes in angle of the field of view.
4. The value of the modulation transfer function (MTF) is greater than 0.581 at various field-of-view (FOV) angles, indicating that the system has rather high image quality.
5. The complexity of the extended-reality glasses system is effectively reduced in comparison with that of the prior art.
6. Assembly can be carried out more efficiently than with the prior art, and cost can be reduced in comparison with that of the prior art.

### BRIEF DESCRIPTION OF THE SEVERAL VIEWS OF THE DRAWINGS

The structure and the technical means adopted by the present invention to achieve the above and other objects can be best understood by referring to the following detailed description of the preferred embodiments and the accompanying drawings, wherein:

FIG. 1 shows an embodiment of an extended-reality glasses system with a zoom projection lens;

FIG. 2 is a sectional view of the zoom projection lens;

FIG. 3 shows how a first focal-length-adjusting gap and a second focal-length-adjusting gap are changed to vary the FOV angle;

FIG. 4 shows a zoom curve diagram of the zoom projection lens;

FIG. 5A shows the MTF curve diagram and the distortion graph of the zoom projection lens when the FOV angle is 50°;

FIG. 5B shows the MTF curve diagram and the distortion graph of the zoom projection lens when the FOV angle is 45°;

FIG. 5C shows the MTF curve diagram and the distortion graph of the zoom projection lens when the FOV angle is 40°;

FIG. 5D shows the MTF curve diagram and the distortion graph of the zoom projection lens when the FOV angle is 35°; and

FIG. 5E shows the MTF curve diagram and the distortion graph of the zoom projection lens when the FOV angle is 30°.

### DETAILED DESCRIPTION OF THE INVENTION

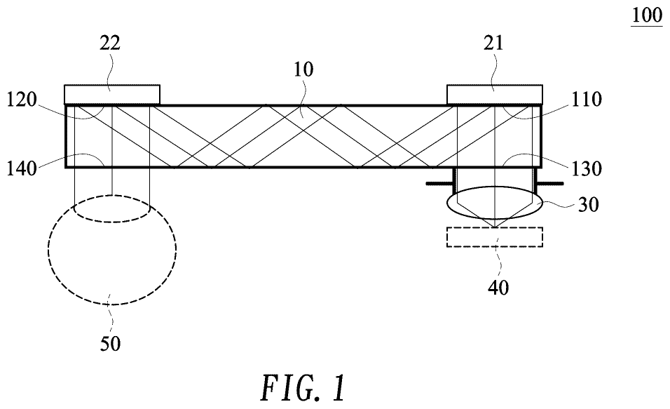

Referring to FIG. 1, the illustrated embodiment provides an extended-reality glasses system 100 having a zoom projection lens. The extended-reality glasses system 100 includes: a light guide element 10, a first volume holographic element 21, a second volume holographic element 22, and a zoom projection lens 30.

The light guide element 10 has a first light-coupling portion 110, a second light-coupling portion 120, a third light-coupling portion 130, and a fourth light-coupling portion 140. The first volume holographic element 21 is provided at a position corresponding to the first light-coupling portion 110 and is optically coupled to the first light-coupling portion 110. The second volume holographic element 22 is provided at a position corresponding to the second light-coupling portion 120 and is optically coupled to the second light-coupling portion 120. The zoom projection lens 30 is provided at a position corresponding to the third light-coupling portion 130 and is optically coupled to the third light-coupling portion 130.

During use, a display device 40 projects an image to the third light-coupling portion 130 through the zoom projection lens 30, and the image is subsequently transmitted through the light guide element 10, the first volume holographic element 21, and the second volume holographic element 22 and is eventually output through the fourth light-coupling portion 140 so as to be received by a human eye or image-taking device 50.

The first volume holographic element 21 and/or the second volume holographic element 22 may be provided with an optical grating for converting the image input through the third light-coupling portion 130 from one-dimensional to two-dimensional, in order for the fourth light-coupling portion 140 to output a two-dimensional image and thereby meet the two-dimensional vision/image requirement of the human eye or image-taking device 50.

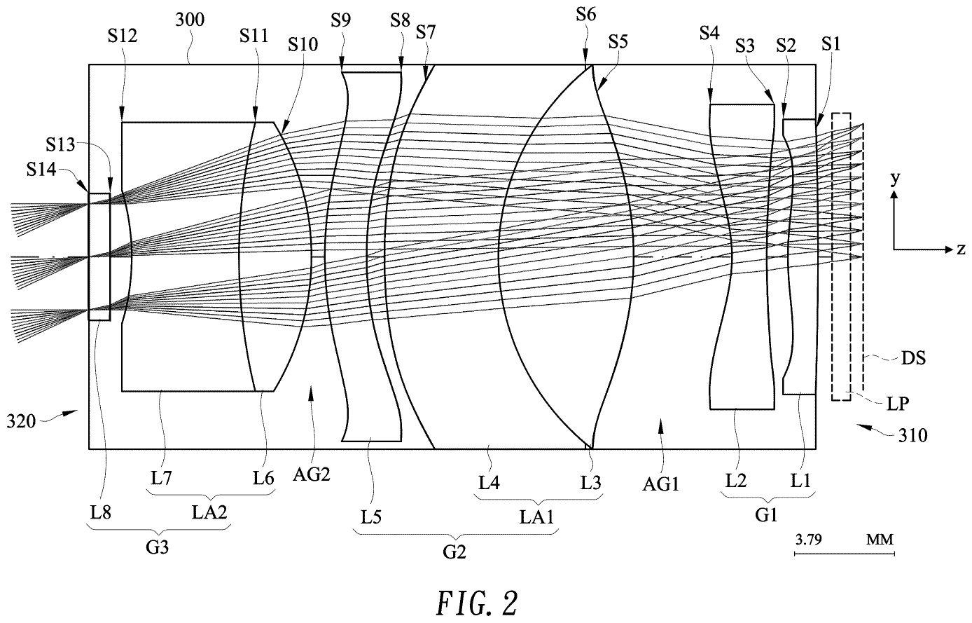

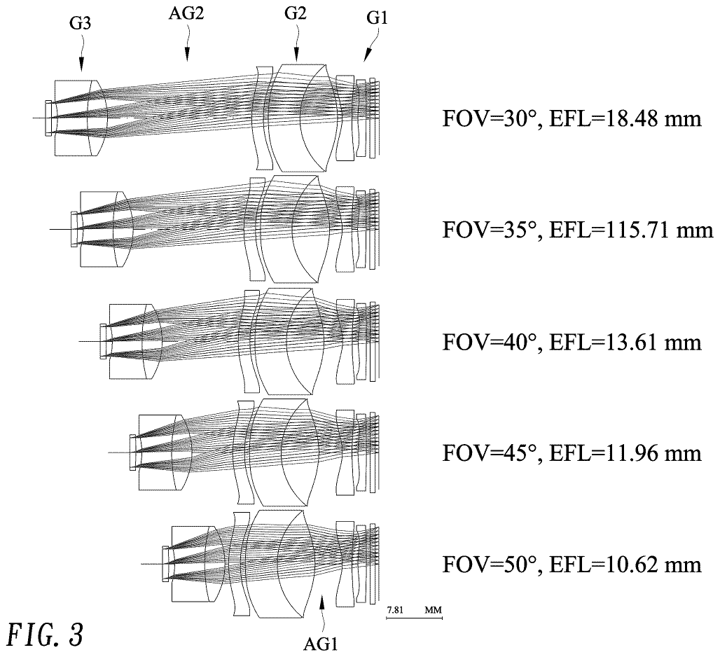

Referring to FIG. 2 and FIG. 3, the zoom projection lens 30 includes: a lens housing 300, a first lens group G1, a second lens group G2, and a third lens group G3. To achieve optimal image quality, the first lens group G1, the second lens group G2, and the third lens group G3 are a negative-dioptric-power lens group, a positive-dioptric-power lens group, and another positive-dioptric-power lens group, respectively.

The lens housing 300 is the main supporting structure of the zoom projection lens 30. The lens housing 300 is formed with a lens-housing light input surface 310 and a lens-housing light output surface 320. The volume of the zoom projection lens 30 is in the range from 2 cc to 6 cc.

The first lens group G1 has: a first lens L1 and a second lens L2.

The first lens L1 has a first spherical light input surface S1 and a second aspherical light output surface S2. The first spherical light input surface S1 is optically coupled to the lens-housing light input surface 310; in other words, the first lens L1 is provided at a position adjacent to the lens-housing light input surface 310.

The second lens L2 has a third spherical light input surface S3 and a fourth aspherical light output surface S4. The third spherical light input surface S3 is optically coupled to the second aspherical light output surface S2.

The second lens group G2 has: a first lens assembly LA1 and a fifth lens L5.

The first lens assembly LA1 has a fifth aspherical light input surface S5, a sixth spherical adhesive bonding surface S6, and a seventh aspherical light output surface S7, wherein the fifth aspherical light input surface S5 is optically coupled to the fourth aspherical light output surface S4. More specifically, the first lens assembly LA1 is composed of a third lens L3 and a fourth lens L4 that are adhesively bonded together, and the sixth spherical adhesive bonding surface S6 is formed between the third lens L3 and the fourth lens L4.

The fifth lens L5 has an eighth aspherical light input surface S8 and a ninth aspherical light output surface S9. The eighth aspherical light input surface S8 is optically coupled to the seventh aspherical light output surface S7.

The third lens group G3 has: a second lens assembly LA2 and an eighth lens L8.

The second lens assembly LA2 has a tenth spherical light input surface S10, an eleventh spherical adhesive bonding surface S11, and a twelfth aspherical light output surface S12, wherein the tenth spherical light input surface S10 is optically coupled to the ninth aspherical light output surface S9. More specifically, the second lens assembly LA2 is composed of a sixth lens L6 and a seventh lens L7 that are adhesively bonded together, and the eleventh spherical adhesive bonding surface S11 is formed between the sixth lens L6 and the seventh lens L7.

The eighth lens L8 has a thirteenth spherical light input surface S13 and a fourteenth spherical light output surface S14. The thirteenth spherical light input surface S13 is optically coupled to the twelfth aspherical light output surface S12. The lens-housing light output surface 320 is optically coupled to the fourteenth spherical light output surface S14; in other words, the eighth lens L8 is provided at a position adjacent to the lens-housing light output surface 320.

In addition, a piece of protective glass LP may be provided on the outer side of the display surface DS of the display device 40.

To enable zooming in and out, a first focal-length-adjusting gap AG1 is provided between the first lens group G1 and the second lens group G2, and a second focal-length-adjusting gap AG2 is provided between the second lens group G2 and the third lens group G3. By adjusting the size of the first focal-length-adjusting gap AG1 and/or the second focal-length-adjusting gap AG2, the focal length of the system can be changed in a stepless manner.

Referring to FIG. 3, adjustment of the size of the first focal-length-adjusting gap AG1 and/or the second focal-length-adjusting gap AG2 can bring about an effective focal length (EFL) of 18.48 mm, 15.71 mm, 13.61 mm, 11.96 mm, or 10.62 mm, thereby changing the FOV angle to 30°, 35°, 40°, 45°, or 50°, respectively.

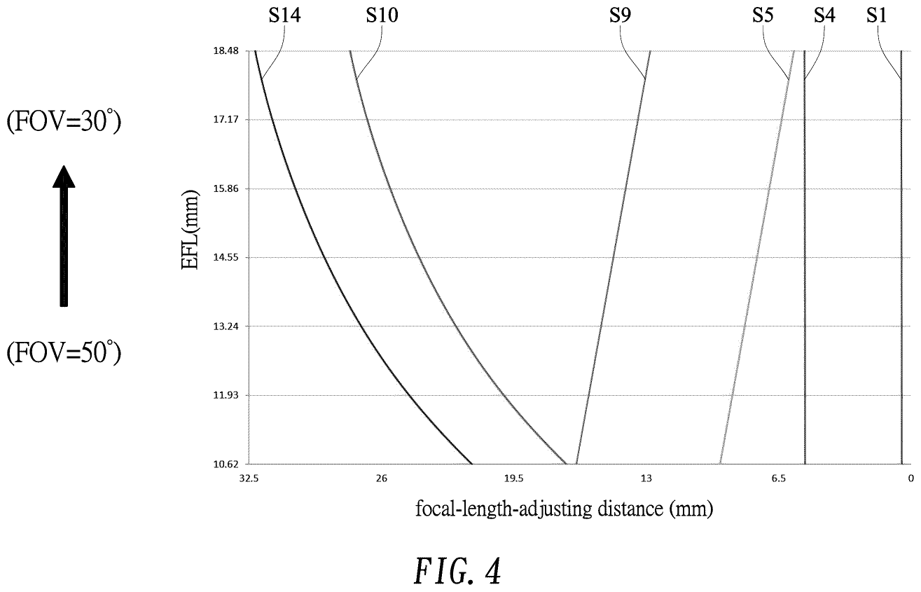

Referring to FIG. 4, the focal-length-adjusting distance in the diagram refers to the distance from the fourth aspherical light output surface S4, the fifth aspherical light input surface S5, the ninth aspherical light output surface S9, the tenth spherical light input surface S10, or the fourteenth spherical light output surface S14 to the first spherical light input surface S1. When any of the focal-length-adjusting distances is changed, a different first focal-length-adjusting gap AG1 and/or second focal-length-adjusting gap AG2 results, and the EFL of the zoom projection lens 30 is changed accordingly to produce different fields of view, with the FOV angle ranging from 30° to 50°.

To achieve an optimal optical effect, some important parameters of the zoom projection lens 30 are set as follow: the FOV angle of the zoom projection lens 30 is adjustable between 30° and 50°; the EFL of the zoom projection lens 30 is adjustable between 10.62 mm and 18.48 mm; the exit pupil diameter of the zoom projection lens 30 is 4 mm; and the maximum effective diameter of the zoom projection lens 30 is in the range from 8 mm to 12 mm.

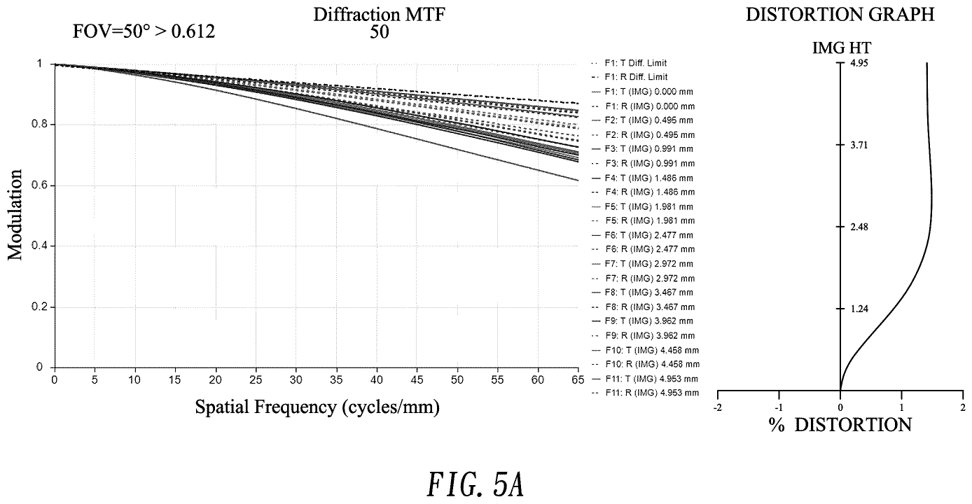

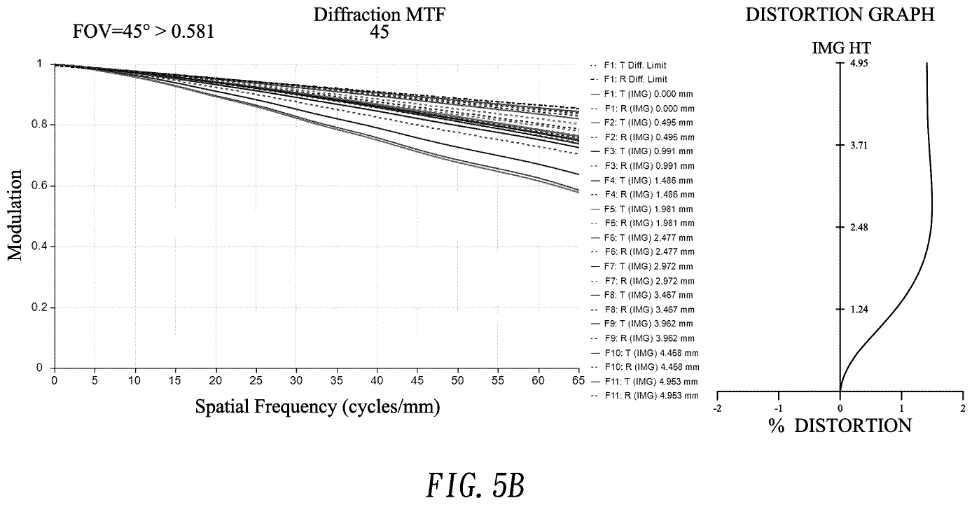

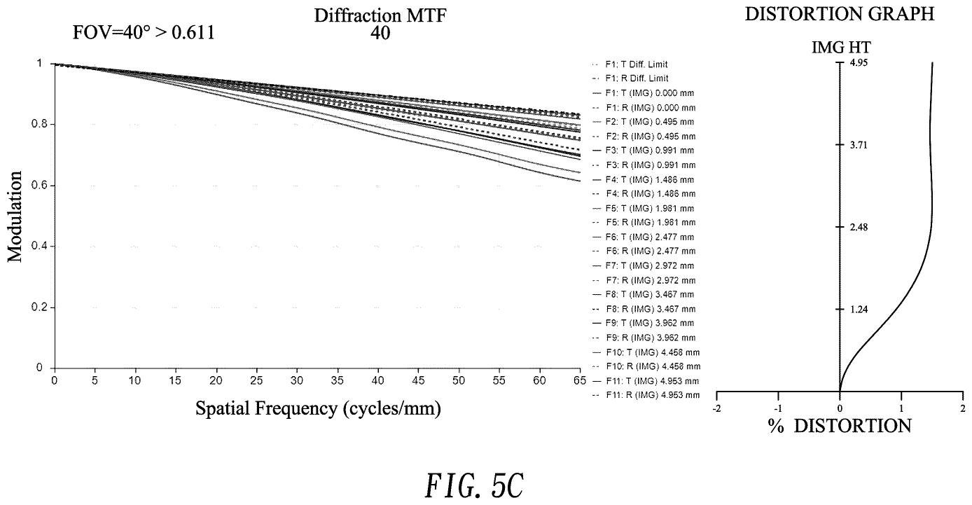

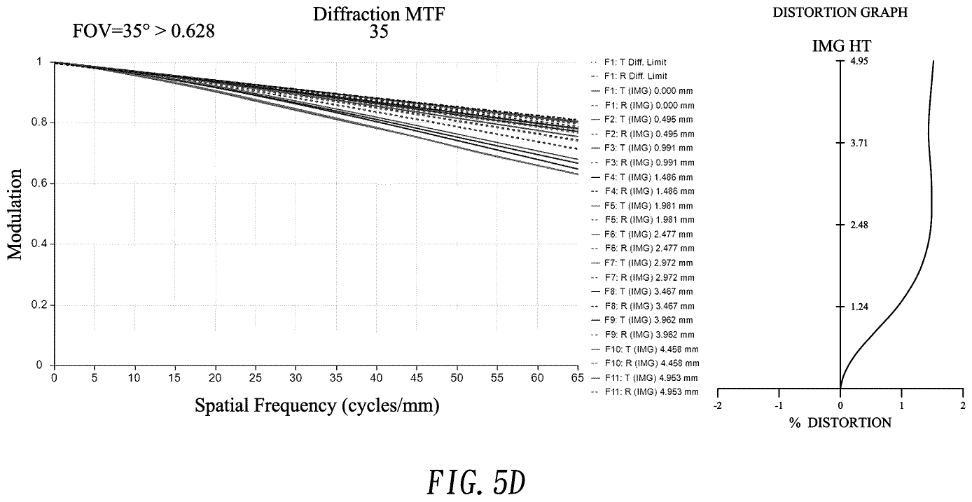

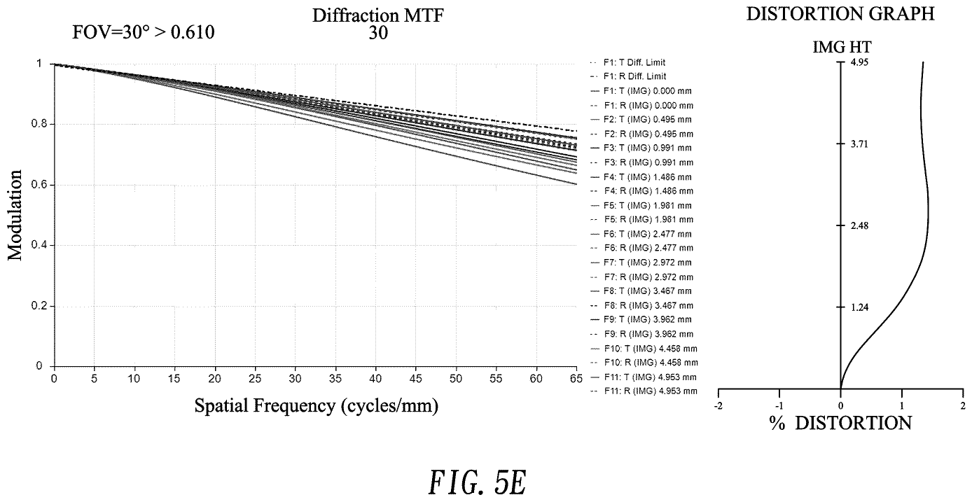

FIG. 5A to FIG. 5E show the modulation transfer function (MTF) curve diagrams that correspond to the FOV angles of 50°, 45°, 40°, 35°, and 30°. In each MTF curve diagram, F1 -F11 represent adjacent fields of view each spanning 0.495 mm, and the curves are divided into tangential (X)-direction curves and radial (Y)-direction curves. It can be seen in the MTF curve diagrams that, with the spatial frequency being less than or equal to 65 cycles/mm, the modulation is greater than or equal to 0.612, 0.581, 0.611, 0.628, or 0.610 when the FOV angle is 50°, 45°, 40°, 35°, or 30°, respectively.

It can also be seen in the distortion graphs in FIG. 5A to FIG. 5E that, with the image half-height (IMG HT) on the display panel being less than or equal to 4.95 mm, and the FOV angle being 50°, 45°, 40°, 35°, or 30°, the absolute value of optical distortion is less than or equal to 1.5% (i.e., |optical distortion|≤1.5%) while the absolute value of TV distortion is less than or equal to 0.15% (i.e., |TV distortion|≤0.15%).

It should be pointed out that in this embodiment, the aforesaid angles 50°, 45°, 40°, 35°, and 30°are provided only to facilitate description. In practice, the size of the first focal-length-adjusting gap AG1 and/or the second focal-length-adjusting gap AG2 can be changed to any value greater than 0 in a stepless manner, thereby varying the FOV angle between 50° and 30° in a stepless manner.

The above description is only the preferred embodiments of the present invention, and is not intended to limit the present invention in any form. Although the invention has been disclosed as above in the preferred embodiments, they are not intended to limit the invention. A person skilled in the relevant art will recognize that equivalent embodiment modified and varied as equivalent changes disclosed above can be used without parting from the scope of the technical solution of the present invention. All the simple modification, equivalent changes and modifications of the above embodiments according to the material contents of the invention shall be within the scope of the technical solution of the present invention.

What is claimed is:

1. An extended-reality glasses system with a zoom projection lens, comprising:
a light guide element having a first light-coupling portion, a second light-coupling portion, a third light-coupling portion, and a fourth light-coupling portion;
a first volume holographic element provided at a position corresponding to the first light-coupling portion, wherein the first volume holographic element is optically coupled to the first light-coupling portion;
a second volume holographic element provided at a position corresponding to the second light-coupling portion, wherein the second volume holographic element is optically coupled to the second light-coupling portion; and
the zoom projection lens, which is provided at a position corresponding to the third light-coupling portion and is optically coupled to the third light-coupling portion.

2. The extended-reality glasses system of claim 1, wherein the zoom projection lens comprises:
a lens housing having a lens-housing light input surface and a lens-housing light output surface;
a first lens group having:
a first lens having a first spherical light input surface and a second aspherical light output surface, wherein the first spherical light input surface is optically coupled to the lens-housing light input surface; and
a second lens having a third spherical light input surface and a fourth aspherical light output surface, wherein the third spherical light input surface is optically coupled to the second aspherical light output surface;
a second lens group having:
a first lens assembly having a fifth aspherical light input surface, a sixth spherical adhesive bonding surface, and a seventh aspherical light output surface, wherein the fifth aspherical light input surface is optically coupled to the fourth aspherical light output surface; and
a fifth lens having an eighth aspherical light input surface and a ninth aspherical light output surface, wherein the eighth aspherical light input surface is optically coupled to the seventh aspherical light output surface; and
a third lens group having:
a second lens assembly having a tenth spherical light input surface, an eleventh spherical adhesive bonding surface, and a twelfth aspherical light output surface, wherein the tenth spherical light input surface is optically coupled to the ninth aspherical light output surface; and
an eighth lens having a thirteenth spherical light input surface and a fourteenth spherical light output surface, wherein the thirteenth spherical light input surface is optically coupled to the twelfth aspherical light output surface, and wherein the lens-housing light output surface is optically coupled to the fourteenth spherical light output surface;
wherein a first focal-length-adjusting gap is provided between the first lens group and the second lens group, and a second focal-length-adjusting gap is provided between the second lens group and the third lens group.

3. The extended-reality glasses system of claim 2, wherein the first lens assembly is composed of a third lens and a fourth lens adhesively bonded to the third lens, and the sixth spherical adhesive bonding surface is formed between the third lens and the fourth lens.

4. The extended-reality glasses system of claim 2, wherein the second lens assembly is composed of a sixth lens and a seventh lens adhesively bonded to the sixth lens, and the eleventh spherical adhesive bonding surface is formed between the sixth lens and the seventh lens.

5. The extended-reality glasses system of claim 2, wherein the zoom projection lens has an adjustable field-of-view (FOV) angle ranging from 30°to 50°.

6. The extended-reality glasses system of claim 2, wherein the zoom projection lens has an adjustable effective focal length (EFL) ranging from 10.62 mm to 18.48 mm.

7. The extended-reality glasses system of claim 2, wherein the zoom projection lens has an exit pupil diameter of 4 mm.

8. The extended-reality glasses system of claim 2, wherein the zoom projection lens has a maximum effective diameter in a range from 8 mm to 12 mm.

9. The extended-reality glasses system of claim 2, wherein the zoom projection lens has a volume in a range from 2 cc to 6 cc.

10. The extended-reality glasses system of claim 2, wherein the first lens group, the second lens group, and the third lens group of the zoom projection lens are a lens group with negative dioptric power, a lens group with positive dioptric power, and another lens group with positive dioptric power, respectively.
